(19) United States
(12) Patent Application Publication
(10) Pub. No.: US 2024/0052518 A1
(43) Pub. Date: Feb. 15, 2024

(54) METHODS OF REFRESHING PLATING BATHS CONTAINING PHOSPHATE ANIONS

(71) Applicant: Honeywell International Inc., Charlotte, NC (US)

(72) Inventors: Gangmin CAO, Shanghai (CN); Jingkang LV, Shanghai (CN)

(21) Appl. No.: 17/886,741

(22) Filed: Aug. 12, 2022

(51) Int. Cl. C25D 21/16; C25D 3/12

(52) U.S. Cl. CPC C25D 21/16; C25D 3/12

(57) ABSTRACT

Methods of refreshing plating solutions containing phosphate anions, refreshed plating solutions, and uses thereof are described. The method may include adding a metal sulfate to the plating solution; precipitating out phosphate anions present in the plating solution with metal ions from the metal sulfate; adding barium carbonate to the plating solution; precipitating sulfate introduced from the metal sulfate added to the plating solution with barium from the barium carbonate; separating insoluble components from the plating solution; and replenishing the plating solution with components originally present in the plating solution.

### TECHNICAL FIELD

Various embodiments of the present disclosure relate generally to the field of plating and, more particularly, to methods of refreshing plating solutions, refreshed plating solutions, and uses thereof.

### BACKGROUND

Various types of objects (e.g., metal objects), including tools and equipment, such as drill pipes, rotors, rollers, and other machinery parts are plated in plating solution baths using a plating process. A plating process, such as electroplating or electroless plating, may be used to apply a layer (e.g., coating) of a metal or alloy from a plating bath on the object. The applied coating may provide a protective barrier that improves, for example, the corrosion resistance, strength, and/or durability of the object. Some plating solutions may include a source of phosphorous (e.g., phosphorous acid) to provide a metal-phosphorous alloy coating. However, the continuous use of phosphorous containing plating baths may result in an accumulation of phosphate anions.

Phosphate anions may accumulate within plating solution baths due to the oxidation of phosphorous acid present within the solution as well as other side effects of the plating operation. The accumulation of phosphate anions may decrease the overall performance of the plating bath and may result in the bath becoming unusable. Replacement and disposal of phosphorous containing plating baths each time there is an accumulation of phosphate anions may be expensive. Various methods, including precipitation methods, are used to remove phosphorus species from aged or spent plating baths. However, these methods may introduce excess ions and/or unwanted materials, which may also interfere with the plating operation. Thus, there is a need for an efficient and cost effective solution for increasing plating bath life by removing phosphate anions without introducing excess and/or unwanted substances.

The present disclosure is directed to overcoming one or more of these challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, refreshed plating solutions and methods of refreshing plating solutions containing phosphate anions for improved plating processes are provided in this disclosure.

In one embodiment, a method of refreshing a plating solution is disclosed. The method may include: adding a metal sulfate to the plating solution; precipitating out phosphate anions present in the plating solution with metal ions from the metal sulfate; adding barium carbonate to the plating solution; precipitating sulfate introduced from the metal sulfate added to the plating solution with barium from the barium carbonate; separating insoluble components from the plating solution; and replenishing the plating solution with components originally present in the plating solution. In some examples, the components originally present in the plating solution may include a source of cobalt or nickel, phosphorous acid, and additives. In at least one example, the metal sulfate may be iron (III) sulfate. In aspects of the present disclosure, replenishing the plating solution with components originally present in the plating solution may restore a pH of the plating solution. For example, the pH of the plating solution may range from about 1.8 to about 2. Also disclosed herein, is a refreshed plating solution prepared according to the above method.

In another embodiment, a method of assessing a refreshed plating solution is disclosed. The method may include: (a) generating a refreshed plating solution from a plating solution after the plating solution has been aged from an original plating solution; (b) electroplating a dummy cathode with the refreshed plating solution; and comparing properties of a coating produced in step b. with properties of a coating produced by electroplating with the original plating solution. In some examples, each of the refreshed plating solution and the original plating solution may comprise cobalt, phosphorous acid, and abrasive particles. For example, the abrasive particles may include boron carbide, boron nitride, silicon carbide, aluminum oxide, or a combination thereof.

In yet another embodiment, another method of refreshing a plating solution is disclosed. The method may include: determining a total amount of phosphite anions and phosphate anions in the plating solution; determining an amount of a metal sulfate compound required to precipitate the total amount of phosphite anions and phosphate anions; adding the determined amount of the metal sulfate compound to the plating solution; maintaining the metal sulfate compound in the plating solution for a period of time sufficient to achieve precipitation of the total amount of phosphite anions and phosphate anions; determining an amount of barium carbonate needed to precipitate the amount of sulfate introduced from the metal sulfate compound added to the plating solution; adding the determined about of barium carbonate to the plating solution; and maintaining the barium carbonate in the plating solution to achieve the precipitation of the sulfate. The method may also include separating the precipitates from the plating solution; adjusting a pH of the plating solution to cause precipitation; and adding components back to the plating solution to produce a refreshed plating solution.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed methods is the generation of a refreshed (e.g., regenerated) plating solution that is capable of being reused and providing desirable coating properties.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary plating system, according to one or more aspects of the present disclosure.

FIG. 2 depicts a flowchart of an exemplary method of refreshing a plating solution, according to one or more aspects of the present disclosure.

FIG. 3 depicts a flowchart of another exemplary method of refreshing a plating solution, according to one or more aspects of the present disclosure.

FIG. 4 depicts a flowchart of a method for assessing a refreshed plating solution, according to one or more aspects of the present disclosure.

FIG. 5 depicts images from assessing a refreshed plating solution, produced according to Example 1.

### DETAILED DESCRIPTION OF EMBODIMENTS

The following embodiments describe methods of refreshing plating solutions containing phosphate anions, refreshed plating solutions, and uses thereof, in accordance with one or more aspects of the present disclosure.

As described above, there is a need in the plating technology field to efficiently remove phosphate anions from plating baths without introducing excess or unwanted materials, while generating a refreshed plating bath suitable for long term, repeated use. For example, an accumulation of phosphate anions in phosphorous containing plating solutions as a result of exposure to air (e.g., oxidation) and other side reactions during a plating operation may interfere with the plating process and may render the plating solution unusable. Further, phosphate anion accumulation may prevent the continuous use of plating baths containing phosphate anions and may result in a costly replacement process. The addition of certain precipitating agents, such as certain metal salts, to remove the phosphate anions, may also lead to an accumulation or buildup of the added metal cation(s) or anion(s) within the plating bath, which may further interfere with the plating operation. Accordingly, the following embodiments describe methods of refreshing a plating solution comprising phosphate anions by removing the phosphate anions as well as other excess and/or unwanted components and restoring the plating solution back to its original state for reuse.

According to certain aspects of the present disclosure, a metal sulfate may be added to a plating solution and phosphate anions present in the plating solution may be precipitated out with metal ions from the metal sulfate. For example, the plating solution may include a source of cobalt or nickel, phosphorous acid, and additives. The metal sulfate may be added to the plating solution after an accumulation of phosphate has been detected. Next, barium carbonate may be added to the plating solution. Sulfate introduced from the metal sulfate that has been added to the plating solution may be precipitated with barium from the barium carbonate. Insoluble components may be separated from the plating solution and the plating solution may be replenished with components originally present in the plating solution.

In other aspects of the present disclosure, a total amount of phosphite anions and phosphate anions in a plating solution may be determined. Next, an amount of a metal sulfate compound required to precipitate the total amount of phosphite anions and phosphate anions may be determined. The determined amount of the metal sulfate compound may be added to the plating solution and the metal sulfate compound may be maintained in the plating solution for a period of time sufficient to achieve precipitation of the total amount of phosphite anions and phosphate anions. An amount of barium carbonate needed to precipitate the amount of sulfate introduced from the metal sulfate compound added to the plating solution may be determined and the determined amount of barium carbonate may be added to the plating solution. The barium carbonate may be maintained in the plating solution to achieve precipitation of the sulfate. The precipitates may be separated from the plating solution and original components (e.g., source of cobalt or nickel, phosphorous acid, and abrasive particles) may be added back to the plating solution.

Accordingly, the methods of the present disclosure may significantly reduce or prevent the above-described accumulation of phosphate anions in an aged plating solution as well as the accumulation of excess substances (e.g., ions), by precipitating and removing phosphate anions, phosphite anions, and sulfate ions introduced from the metal sulfate used to precipitate the phosphorus species. Furthermore, the methods of the present disclosure may significantly reduce the costs associated with plating baths and eliminate the need for immediate disposal and replacement upon aging by replenishing an aged plating solution for reuse.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The terms “approximately” and “about” refer to being nearly the same as a referenced number or value. Relative terms, such as, “substantially,” “approximately,” “about,” and “generally,” are used to indicate a possible variation of ±10% of a stated or understood value. All ranges are understood to include endpoints, e.g., a pH range from 1 to 3, includes a pH of 1, 3, and all pH values between.

The term “refresh” may be used interchangeably with “regenerate,” “rejuvenate,” “replenish,” “restore,” and the like throughout this application. The term “work piece” may be used interchangeably with “article of manufacture” and the like throughout this application. The terms “aged” and “spent” may be used to describe a plating solution that has become depleted and that exhibits a decreased performance or is unusable.

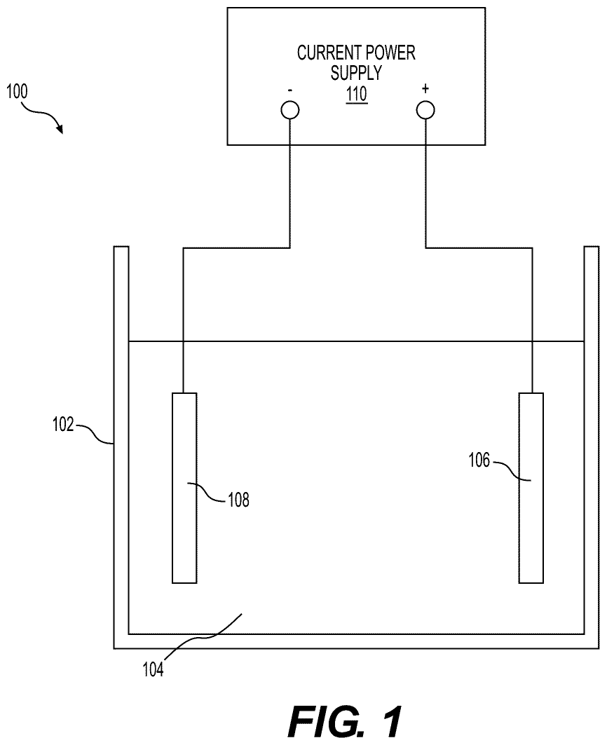

Referring now to the appended drawings, FIG. 1 illustrates an exemplary plating system 100, according to one or more aspects of the present disclosure. For example, the plating system 100 may be an electroplating system. The system 100 may include a plating bath (or tank or container) 102, a plating solution 104, anode (or anode electrode) 106, cathode (or cathode electrode) 108, and a power supply 110. The power supply 110 may be a variable power supply. The plating bath 102 may be configured to receive the plating solution 104. It is understood that the components shown in FIG. 1 are exemplary only and non-limiting alternatives are discussed herein.

Still referring to FIG. 1, anode 106 and cathode 108 may be coupled to or placed in the plating bath 102. The anode 106 and cathode 108 may be arranged in the plating bath 102, so as to be in contact, fully or partially, with the plating solution 104. Cathode 108 may represent a substrate or article of manufacture (not shown in the figure for brevity and clarity) to be electroplated (e.g., coated). For example, an article of manufacture may be hooked as cathode 108 and immersed in the plating solution 104. The article of manufacture (substrate) may be composed of metals and metal alloys, including but not limited to, nickel, iron, steel, aluminum, brass, platinum, chromium, tungsten, titanium, and tin. Anode 106 and cathode 108 may provide various levels of electric current necessary to facilitate electroplating the article of manufacture (e.g., cathode 108), such that electroplating coating layers are applied. The electric current may initiate a chemical reaction between the plating solution 104 and the article of manufacture (substrate) in the plating bath 102. In some examples, anode 106 may include one or more anodes (or anode electrodes) and cathode 108 may include one or more cathodes (or cathode electrodes). Furthermore, an article of manufacture may include one or more work pieces (e.g., a shaft, rod, beam, cylinder, bar, etc.).

In some embodiments, plating solution 104 may include a source of at least one transition metal, a source of phosphorous, and one or more additives. The source of the at least one transition metal may include a source of cobalt ions, a source of nickel ions, or a combination thereof. For example, plating solution 104 may include a cobalt phosphorous (Co—P) solution. Alternatively, plating solution 104 may include a nickel phosphorous (Ni—P) solution. Various sources may be used to provide cobalt in plating solutions according to the present disclosure. In some examples, cobalt (II) sulfate may be a source of the cobalt ions. For example, CoSO₄·7H₂O or CoSO₄·6H₂O may be used to provide the cobalt ions. Other sources of cobalt ions may include cobalt (H) carbonate (CoCO₃), cobalt (H) chloride (e.g., CoCl₂·6H₂O), and cobalt (II) sulfamate (e.g. Co(SO₃NH₂)₂). Various sources may be used to provide nickel in plating solutions according to the present disclosure. In some examples, nickel (II) sulfate may be a source of the nickel ions. For example, NiSO₄·7H₂O may be used to provide the nickel ions. Other sources of nickel ions may include nickel (II) chloride (e.g., NiCl₂·6H₂O) and nickel (II) sulfamate (e.g., Ni(SO₃NH₂)₂).

Phosphorous acid (H₃PO₃) may serve as a source of phosphorous within the plating solution 104. Other sources for phosphorous may include hypophosphorous acid and salts thereof (e.g., sodium hypophosphite). Phosphorous acid may provide the plating solution 104 with phosphite (PO₃⁻³) anions, as discussed in further detail below.

The one or more additives within the plating solution 104 may include a source of boron and one or more insoluble materials (e.g., abrasive powders). An exemplary source of boron for use in the present disclosure is boric acid. Other sources of boron may include perborate. Exemplary insoluble materials may include oxides (e.g., aluminum oxide (Al₂O₃), silicon dioxide (SiO₂), etc.), carbides (e.g., boron carbide (B₄C), silicon carbide (SiC), etc.), nitrides (e.g., boron nitride (BN)), inorganic fine particulates, and fibers. In at least one example, the insoluble material in the plating solution 104 may include boron carbide (B₄C), boron nitride (BN), silicon carbide (SiC), aluminum oxide (Al₂O₃), or a combination thereof. The one or more insoluble materials (e.g., abrasive powders) may be dispersed throughout the plating solution 104 and may be co-deposited with the solution in layers on the substrate. The source of boron and/or one or more insoluble materials may be used to enhance the coating (e.g., applied coating layer(s)) wear resistance. In some examples, the source of boron and/or one or more insoluble materials may be optional, and thus may not be present in plating solution 104.

The size of the plating bath 102 may be designed to be any size suitable for plating, such as via electroplating or electroless plating, various parts and work pieces. In some examples herein, the final volume of the plating bath 102 comprising plating solution 104 may be based on 1000 mL (1 liter). In other examples, the final volume of the plating bath 102 comprising plating solution 104 may be based on 5000 mL (5 liters) or 10,000 mL (10 liters). Plating baths herein may be designed for industrial scale operation. The plating baths of the present disclosure may range in size from about 1 liter to about 100,000 liters. Exemplary plating bath volumes may include 50 liters, 100 liters, 5,000 liters, and 10,000 liters.

An exemplary plating (e.g., electroplating) solution according to the present disclosure, such as the plating solution 104 of FIG. 1, may include cobalt ions, boric acid, boron carbide particles, and phosphite anions. The phosphite anions may be provided by phosphorous acid. During a plating process, such as an electroplating process that occurs in the plating bath 102, phosphorous acid present within the bath may be oxidized to phosphoric acid (H₃PO₄). As a result, phosphate anions (PO₄⁻³) may be generated due to oxidation of phosphite. Over time, as the bath (e.g., electroplating bath 102) is continuously used and ages, the concentration of phosphate may increase and may lead to a buildup of phosphate. Without being bound by theory, it is believed that phosphate accumulation decreases the plating rate. As the plating rate decreases, the plating bath may contain both accumulated phosphate as well as remaining phosphite. When phosphate accumulation is detected in a plating bath, the plating solution may be refreshed according to methods of the present disclosure.

The manner in which various components are arranged in FIG. 1 is merely exemplary. In practice, there may be additional components, fewer components, different components, or differently arranged components than those shown in FIG. 1. In some examples, the methods according to the present disclosure may be performed with an electroless plating system. As such, the present disclosure also encompasses embodiments where an electric current is not supplied to a plating bath. In these examples, power supply 110, which supplies the current, and anode 106 may be removed from FIG. 1. An article of manufacture, depicted in FIG. 1 as cathode 108, may remain in the plating bath 102 to be coated by plating solution 104, sans the electrical charge. In certain electroless plating examples, the plating solution (e.g., plating solution 104) may comprise nickel ions.

During an electroless plating process, phosphorous acid may serve as a reducing agent. Metal (e.g., nickel) ions present in the plating solution, such as plating solution 104, may be reduced by phosphorous acid. While the main reaction occurs between metal (e.g., nickel) ions and phosphorous acid, the phosphorous acid may be oxidized to phosphoric acid (H₃PO₄). As a result, phosphate anions (PO₄⁻³) may be generated as a reaction by-product due to the oxidation of phosphite present in the plating solution. The oxidation may occur due to an exposure of the plating solution/bath to air. Similar to electroplating solutions comprising accumulated phosphate as described above, electroless plating solutions comprising accumulated phosphate may be refreshed according to methods of the present disclosure.

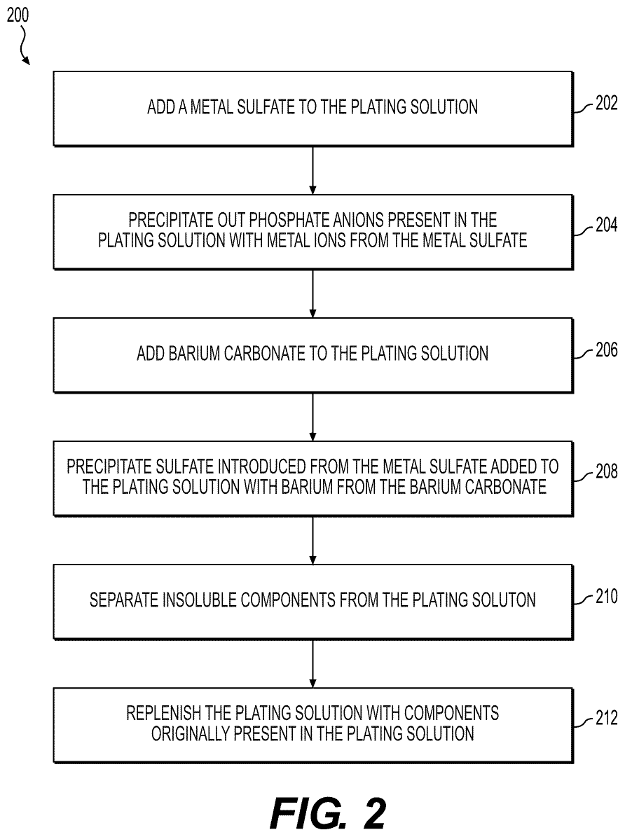

FIG. 2 depicts an exemplary method 200 for refreshing a plating solution, according to one or more aspects of the present disclosure. Method 200 may be used to refresh a plating bath or plating solution comprising accumulated phosphate anions. For example, the method may be used to refresh a plating solution, such as plating solution 104 discussed above with respect to FIG. 1, when the plating solution has been aged and comprises a buildup of phosphate. Method 200 may result in the removal of accumulated phosphate from a solution.

In step 202, a metal sulfate may be added to a plating solution. For example, a metal sulfate may be added to a plating solution comprising phosphate. In particular, the plating solution may be characterized by phosphate buildup or accumulation. The plating solution may be contained and used in a plating bath. The plating solution, in step 202, to which a metal sulfate is added, may be derived from an original plating solution. The original plating solution may comprise a source of a transition metal, a source of phosphorous, and one or more additives. In some examples, the original plating solution, from which the plating solution in step 202 is derived, may comprise a source of cobalt, providing cobalt ions. In other examples, the original plating solution may comprise a source of nickel, providing nickel ions. The source of phosphorous may be phosphorous acid, providing phosphite anions. During a plating process, the phosphite in the plating solution may be oxidized to phosphate.

A metal sulfate may be added to an aged plating solution derived from an original plating solution comprising cobalt ions or nickel ions and phosphite ions that has been subjected to continuous use in a plating operation. In some examples, the metal sulfate may be added to the plating solution after an accumulation of phosphate has been detected. In some embodiments, an accumulation of phosphate may be determined when the concentration of phosphate anions exceeds about 0.63 mol/L.

The metal sulfate added to the plating solution in step 202 is added for the purpose of precipitating the phosphate anions present in the plating solution. The metal sulfate may be selected from aluminum sulfate (Al₂(SO₄)₃), iron (II) sulfate (FeSO₄), and iron (III) sulfate (Fe₂(SO₄)₃). The selection of the metal sulfate may be based on pH conditions of the plating solution relative to the solubility of aluminum and iron metal phosphates as a function of pH. It has previously been determined that when residual phosphorus species remaining in a solution is computed based on combined solubility products, acid-base reactions, and dissolved complex formation for precipitation reactions with Fe(III) or Al(III) and phosphate and plotted on a solubility diagram, FePO₄ has a lower solubility in the pH range of 1 to 3 than AlPO₄. (Maurer M. and Boller M. (1999) “Modelling of Phosphororus Precipitation in Wastewater Treatment Plants with Enhanced Biological Phosphorus Removal,” Wat. Sci. Tech. Vol. No. 1, pp. 147-163; Stumm W. and Morgan J. J. (1996) Aquatic Chemistry, 3rd Ed, John Wiley & Sons Inc. ISBN 0 471 51185-4). A typical operation pH range for precipitation with an iron compound is 3 to 4. A typical operation pH range for precipitation with an aluminum compound is 6 to 8. In some examples herein, a plating solution bath used for electroplating and comprising sources of cobalt and phosphorous may be operated in a pH range of about 1.8 to about 2.2, e.g., pH 1.8 to 2. As a result of an exemplary plating solution according to the present disclosure having a pH of about 1.8, iron (III) sulfate may be selected as the metal sulfate for precipitation in the plating bath solution instead of other metal sulfates, such as aluminum sulfate.

Another factor that may be considered in the selection of a metal sulfate, such as one of aluminum sulfate, iron (II) sulfate, and iron (III) sulfate, for adding to the plating bath in step 202, is whether a flocculating agent is required for precipitation in addition to the metal sulfate. Without being bound by theory, it is believed that better precipitation may be achieved with either an aluminum compound or an iron (II) compound in the presence of a flocculating agent. It is also believed that a flocculating agent may not be necessary for use with an iron (III) compound in order to achieve desired precipitation. In some embodiments, the addition of a flocculating with the metal sulfate may introduce additional components into the plating solution. In a preferred embodiment, iron (III) sulfate may be added to the plating solution in step 202.

In step 204, phosphate anions are precipitated out of the plating solution with metal ions from the metal sulfate. After a metal sulfate, such as iron (III) sulfate, is added to the plating solution in step 202, a precipitation reaction may occur. For example, accumulated phosphate anions present in the plating solution (e.g., aged plating solution) may be precipitated with metal cations dissociated from the metal sulfate in the solution. In at least one example, the metal cation used to precipitate the phosphate anions in the plating solution may be Fe³⁺. The precipitation reaction taking place in step 204 may be carried out until complete precipitation of the phosphate present in the plating solution has been achieved.

Still referring to step 204, it may be further recognized that adding the metal sulfate to the plating solution in step 202 and precipitating the phosphate anions present in the plating solution in step 204 may also cause and result in the precipitation of phosphite (e.g., phosphite anions) present in the plating solution. In embodiments of the present disclosure, phosphate accumulated within a plating solution, as a result of the aging and continued use of the plating solution, and phosphite anions also present therein may be removed from the plating solution by steps 202 and 204. The metal ions (e.g., Fe³⁺, Fe²⁺, or Al³⁺) provided by the metal sulfate may precipitate out the phosphate and the phosphite. It may be desirable to precipitate out the phosphite anions from an aged plating bath, since the oxidation of phosphite may generate additional phosphate within the solution, which slows down the plating rate as the concentration of phosphate increases. Precipitation of the phosphate and phosphite anions may occur at substantially the same time. In examples where Fe³⁺ ions precipitate out PO₄⁻³ and PO₃⁻³, the reaction products for the respective reactions may be expected to include FePO₄ (s) and FePO₃ (s), respectively. In examples where Al³⁺ ions precipitate out PO₄⁻³ and PO₃⁻³, the reaction products for the respective reactions may be expected to include AlPO₄ (s) and AlPO₃ (s), respectively. In examples where Fe²⁺ ions precipitate out PO₄⁻³ and PO₃⁻³, the reaction products for the respective reactions may be expected to include Fe₃(PO₄)₂ (s) and Fe₃(PO₃)₂ (s), respectively. In each of these embodiments, the reaction products will also include sulfate anions (SO₄²⁻) provided by the metal sulfate.

In some examples, the plating solution (e.g., plating bath) may be heated and/or agitated during the precipitation reaction to assist with a complete precipitation and to help ensure that the phosphate and phosphite anions are fully precipitated. To facilitate the precipitation reaction in step 204, the plating solution may be heated to a temperature ranging from about 70° C. to about 85° C.

The amount of phosphate and phosphite that is precipitated may constitute up to about 100 wt. % of the phosphate and phosphite in an aged plating solution bath. For example, from about 95 wt. % to about 100 wt % phosphate and phosphite, respectively, may be precipitated out of the plating solution. In some examples, at least about 85 wt. % or at least about 90 wt. % phosphate and phosphite, respectively, may be precipitated out of the plating solution.

In some examples, a decrease in pH value of the plating solution may occur after step 204. For example, the pH of the plating solution bath containing the precipitated phosphate and phosphite may drop or significantly decrease from a pH value of the original plating bath (e.g., the original pH). A significant decrease in pH may be attributed to the addition of the metal sulfate. In examples where the plating solution has a pH of about 2 (e.g., pH 1.8), a drop in pH may be represented by the pH decreasing to a value below 1, such as below 0.75, below 0.5, below 0.3, below 0.25, or below 0.2. A drop in pH may result in the dissolution of the metal phosphate and metal phosphite precipitates back into the plating solution. For example, as the pH of the plating solution significantly decreases, the precipitated phosphates and phosphites (e.g., iron (III) phosphate and iron (III) phosphite) formed in step 204 may dissolve.

In step 206, barium carbonate (BaCO₃) may be added to the plating solution. Barium carbonate may be added after completion of the precipitation reaction, wherein a metal sulfate compound is used to precipitate out the phosphate (and phosphite) anions in the plating solution. The purpose of adding the barium carbonate is to remove the sulfate anions added to the plating solution bath during the step where the metal sulfate compound has been introduced. In some embodiments, the introduction of the metal sulfate in the previous step may lead to an oversaturation of cobalt sulfate (CoSO₄) or nickel sulfate (NiSO₄) in the plating solution, resulting in an excess amount of sulfate anions in the plating solution. The presence of an excess amount of sulfate in the plating solution may also impact the plating operation and is thus undesirable. While step 206 recites adding barium carbonate to the plating solution, another metal carbonate capable of precipitating the sulfate anions may be used as an alternative to the barium carbonate. For example, calcium carbonate (CaCO₃) may be added to the plating solution in step 206. However, adding barium carbonate in step 206 is preferred to ensure that the barium ions are completely removed in the precipitate. The barium carbonate may be slowly added to the plating solution, under agitation/stirring. It is preferred that the barium carbonate is not added all at once.

After the barium carbonate is added, the precipitation reaction occurs in step 208. In step 208, the sulfate introduced from the metal sulfate added to the plating solution in step 202 may be precipitated with barium from the barium carbonate. Step 208 may be conducted under constant agitation. The agitation may be applied to facilitate complete precipitation of the excess sulfate. The barium cations (Ba²⁺) dissociated from the barium carbonate in the plating solution may precipitate the excess sulfate anions (SO₄²⁻). The reaction products from step 208 may include precipitated barium sulfate (BaSO₄) as well as carbon dioxide (CO₂) and water (H₂O). During and/or after the precipitation reaction, the barium sulfate precipitate may be allowed to settle within the plating solution bath. An upper solution and the settled precipitate may be formed.

In step 210, the insoluble components in the plating solution may be separated (e.g., physically separated) from the plating solution. For example, the plating solution obtained after the completion of the precipitation reaction in step 208 may be subjected to a filtration process. The filtration process may include one or more filtration steps. During the filtration process, the plating solution may be filtered to separate the precipitated barium sulfate from the plating solution. Any other insoluble components still remaining in the plating solution may also be removed with the barium sulfate. For example, when abrasive particles, such as boron carbide, are present in the plating solution they may be removed together with the barium sulfate during this filtration step. In some examples, the abrasive particles and/or other insoluble components may be separated from the plating solution earlier in method 200. In at least one example, abrasive particles may be removed from the plating solution bath prior to adding the metal sulfate.

After the insoluble components, including the barium sulfate, have been removed from the plating solution, the plating solution may be refreshed by the addition of depleted components. In step 212, the plating solution may be replenished with components originally present in the plating solution. Furthermore, the pH of the plating solution may be restored to the original pH of the plating solution bath. The replenishment step may include adding back a source of the metal used for plating. In some examples where the plating bath is an electroplating bath, a source of cobalt may be added back to the plating solution. In other examples where the plating bath is an electroless plating bath, a source of nickel may be added back to the plating solution. The plating metal may be added as a carbonate compound to introduce the plating metal back into the plating solution and to raise the pH of the plating solution. For example, cobalt carbonate (CoCO₃) or nickel carbonate (NiCO₃) may be added to the plating solution.

Upon adding the plating metal carbonate to the plating solution, additional precipitation may occur as a result of the increase in pH of the plating solution. In some examples wherein cobalt carbonate is added, the pH may be raised to about 2.0-2.2. The plating solution may be agitated to facilitate complete precipitation and the precipitates may be allowed to settle in the plating solution. For example, raising the pH of the plating solution, such as by the addition of cobalt carbonate or nickel carbonate depending on the composition of the original plating solution, may cause the precipitation of the phosphate and phosphite anions with the metal cations introduced by the metal sulfate added to the plating solution in step 202. As discussed above, a significant decrease in the pH of the plating solution may be observed after the addition of the metal sulfate (e.g., Fe₂(SO₄)₃) at the beginning of method 200. When the pH of the plating solution significantly decreases, the metal phosphate and metal phosphite precipitates previously formed in step 204 may dissolve in the plating solution. Whereas, when the pH of the plating solution significantly increases, the phosphate anions and phosphite anions dissolved in the solution may be precipitated out with the metal cations (e.g., Fe³⁺, Fe²⁺, or Al³⁺) in the solution, thus forming metal phosphate and metal phosphite precipitates. As such, precipitation may be observed within the plating solution again due to the addition of the plating metal carbonate, which raises the pH of the plating solution. The precipitates formed after raising the pH of the plating solution to about 2.0 to about 2.2 may comprise metal phosphate and metal phosphite.

After the precipitation is complete and the precipitates have settled in the plating solution, the plating solution may be filtered to separate the precipitates from the plating solution. In some embodiments, the separation step 210, may be performed throughout method 200, in order to remove or separate (e.g., filter) insoluble components. Separation may be performed prior to step 212 as depicted in the flowchart for method 200, in order to remove at least the barium sulfate precipitate formed from step 208. Separation may also be performed after step 212 to remove the metal phosphate and metal phosphite precipitates formed as a result of a raised pH of the plating solution following the addition of a plating metal carbonate. Any suitable method known in the art for removing or separating a precipitate from a solution may be employed. For example, filtration methods may be used. In some examples, vacuum or suction filtration may be applied. Other separation techniques may also be employed. Other methods of removal or separation may include centrifugation and decanting. The methods disclosed herein may be found to separate and remove either a complete or at least substantial amount of phosphate and phosphite from the plating solution. The filtrate may be in the form of a solution (plating solution) comprising a source of the plating metal present in the original solution. In some examples, the filtrate may comprise mainly cobalt sulfate.

Next, the remaining components present in the original plating solution, including a source of phosphorous, may be added back to the plating solution. The components may be added in concentrations which restore the plating solution to its original condition. The remaining components may include, but are not limited to, at least phosphorous acid (or other source of phosphorous), boric acid, and other additives (e.g., abrasive particles). Exemplary abrasive particles include boron carbide, aluminum carbide, and silicon carbide. The addition of the remaining components may result in further adjustment of the pH of the plating solution and the plating solution may be considered to be refreshed. For example, the pH may be restored back to the pH of the original plating solution to enable reuse of the plating solution under the original operating conditions. In at least one example, the pH of the plating solution may be restored to a pH ranging from about 1.8 to about 2.0.

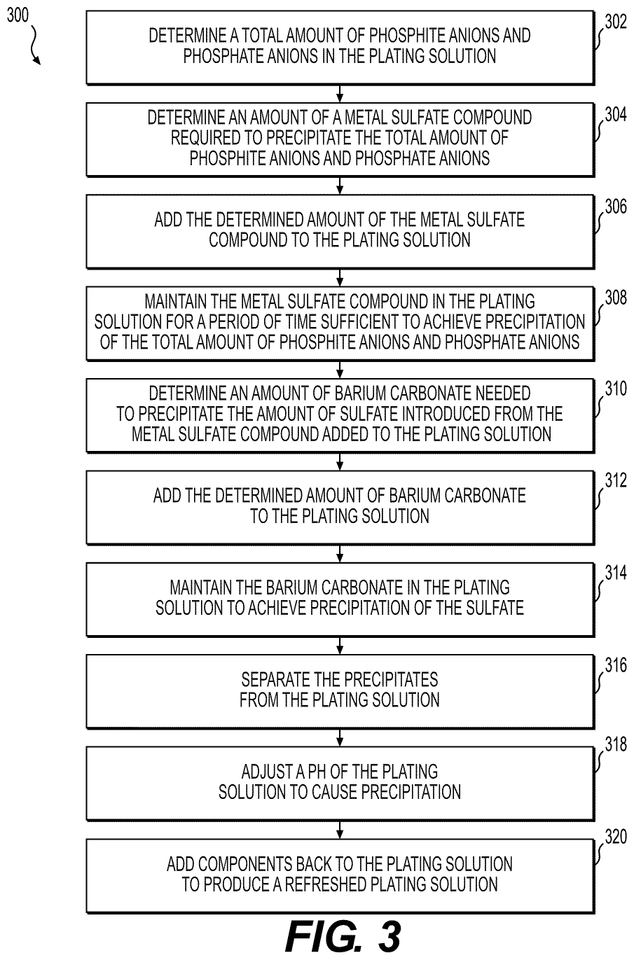

FIG. 3 depicts another exemplary method 300 for refreshing a plating solution, according to one or more aspects of the present disclosure. Method 300 may provide a quantitative solution for treating and refreshing a plating solution, such as plating solution 104 discussed above with respect to FIG. 1, when the plating solution has been aged and comprises a buildup of phosphorus species. The operating conditions and compositional properties of the plating solution described above with respect to method 200, may also apply to method 300.

In step 302, a total amount of phosphite anions and phosphate anions or total P (phosphite+phosphate) in an aged or spent plating solution may be determined. In some embodiments, a molar concentration may be determined. For example, the total amount of phosphite anions and phosphate anions calculated may be based on the total moles of phosphite and phosphate anions per liter of the plating solution bath.

In step 304, an amount of a metal sulfate compound required to precipitate the total amount of phosphite anions and phosphate anions may be determined. As described above with respect to method 200, the metal sulfate compound may be selected from aluminum sulfate (Al₂(SO₄)₃), iron (II) sulfate (FeSO₄), and iron (III) sulfate (Fe₂(SO₄)₃). When calculating the amount of metal sulfate necessary to precipitate the total amount of phosphite anions and phosphate anions (total P), the concentration (e.g., moles) of the metal sulfate should not be more than the concentration (e.g., moles) of total P (phosphite+phosphate) determined in step 302.

In step 306, the amount of metal sulfate compound determined in step 304 is added to the plating solution. In step 308, the metal sulfate compound may be maintained in the plating solution for a period of time sufficient to achieve precipitation of the total amount of phosphite anions and phosphate anions. In some examples, heat and/or agitation may be applied to the plating solution to facilitate the precipitation reaction. For example, the plating solution may be heated to a temperature ranging from about 70° C. to about 85° C. In examples where Fe³⁺ ions precipitate out PO₄⁻³ and PO₃⁻³, the reaction products for the respective reactions may be expected to include FePO₄ (s) and FePO₃ (s), respectively. In examples where Al³⁺ ions precipitate out PO₄⁻³ and PO₃⁻³, the reaction products for the respective reactions may be expected to include AlPO₄ (s) and AlPO₃ (s), respectively. In examples where Fe²⁺ ions precipitate out PO₄⁻³ and PO₃⁻³, the reaction products for the respective reactions may be expected to include Fe₃(PO₄)₂ (s) and Fe₃(PO₃)₂ (s), respectively.

Meanwhile, in step 310, an amount of barium carbonate needed to precipitate the amount of sulfate introduced from the metal sulfate compound added to the plating solution in step 306 may be determined. In step 312, the amount of barium carbonate determined in step 310 may be added to the plating solution. It is preferred that the amount of barium carbonate is gradually (e.g., slowly) added to the plating solution bath. In step 314, the barium carbonate may be maintained in the plating solution to achieve precipitation of the sulfate. In order to facilitate complete precipitation, constant agitation may be maintained throughout the precipitation reaction. The reaction products from step 314 may include precipitated barium sulfate (BaSO₄) as well as carbon dioxide (CO₂) and water (H₂O). The precipitate generated may be allowed to settle within the plating solution. Furthermore, an upper solution may be separated from the plating solution.

In certain aspects of the present disclosure, the following equations may be used to determine the amount of targeted anions for precipitation when iron (III) sulfate (Fe₂(SO₄)₃) is used as the metal sulfate compound.

Y≤X*L Step 304

Z=3*Y Step 310
X (mol/L): molar concentration of total P (phosphite+phosphate anions) in plating solution
Y: total moles of iron (III) sulfate compound
L: volume of plating solution
Z: moles of barium carbonate

For example, X, the molar concentration of the total phosphite and phosphate anions may be determined in step 302. In step 304, Y≤X*L, may be used to determine the amount of the iron (III) sulfate, Y, needed to precipitate the total phosphite anions and phosphate anions, X, in the plating solution, wherein the amount of iron (III) sulfate, Y, is not more than the amount of the total phosphite anions and phosphate anions, X, in the plating solution. In step 310, Z=3*Y, may be used to determine the amount of barium carbonate, Z, needed to precipitate the amount of sulfate introduced from the iron (III) sulfate, Y, added in step 306.

Step 316 includes separating the precipitates from the plating solution. In step 316, at least the precipitated barium sulfate may be separated from the plating solution. Any suitable method known in the art for removing or separating a precipitate from a solution may be employed. For example, filtration methods, such as vacuum (suction) filtration may be used. Other methods of removal or separation may include centrifugation and decanting.

In step 318, the pH of the plating solution may be adjusted (e.g., raised). Upon carrying out the initial precipitation reaction (e.g., step 308) to precipitate the phosphate and phosphite anions in the plating solution, a decrease in the pH of the plating solution bath may be observed. The decrease in pH may cause the phosphate precipitates and phosphite precipitates to dissolve in the plating solution. In order to produce a refreshed plating solution, the pH should be restored to the pH of the original plating solution prior to aging. Therefore, adding a component that raises the pH may be required. In a preferred embodiment, a plating metal carbonate comprising the metal present in the original plating solution (e.g., cobalt carbonate) may be added to the plating solution. As a result, further precipitation within the plating solution may occur. For example, raising the pH of the plating solution may cause the precipitation of the phosphate and phosphite anions with the metal cations introduced by the metal sulfate to appear again. After settlement, following the precipitation reaction, the metal phosphate and metal phosphite precipitates generated due to the pH adjustment or increase may be separated from the plating solution. Although the flowchart for method 300, depicts separating precipitates from the plating solution (step 316) as directly following the precipitation of the sulfate (step 314), separation (e.g., filtration) may be performed at various stages throughout method 300 as well as other refreshment methods of the present disclosure, to remove precipitates and/or other insoluble components.

In step 320, other components present in the original plating solution may be added back (i.e. replenished) to the plating solution. The components added to the plating solution may be based on the composition of the original plating solution. For example, the components may include, but are not limited to, at least phosphorous acid (or other source of phosphorous), boric acid, and other additives (e.g., abrasive particles). Exemplary abrasive particles include boron carbide, aluminum carbide, and silicon carbide. The addition of the components in step 320 may also result in a further pH adjustment that restores the pH of the plating solution to a final pH that corresponds to the pH of the original plating solution.

The refreshed or regenerated plating solutions prepared according to methods of the present disclosure, including methods 200 and 300, are capable of being reused in a plating operation process. Such methods may eliminate the need to dispose of an aged plating bath, used for either electroplating or electroless plating, upon the accumulation of phosphate. In some embodiments, the refreshed plating solution produced according to the methods herein, may be assessed prior to reuse in a plating operation.

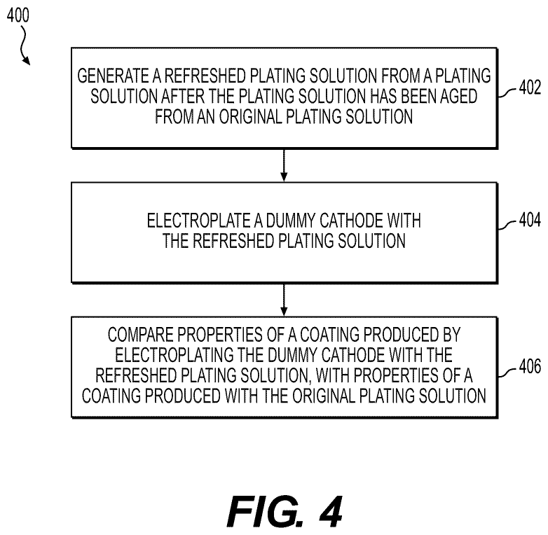

FIG. 4 depicts an exemplary method for assessing a refreshed plating solution, according to one or more aspects of the present disclosure. Method 400 may be used to assess a refreshed plating solution, produced according to one of methods 200 or 300 above, prior to resuming the plating process. The refreshed plating solution assessed in the method 400 may be used for an electroplating operation.

In step 402, a refreshed plating solution may be generated from a plating solution after the plating solution has been aged from an original plating solution. For example, a refreshed plating solution may be generated according to the method 200 as described above, wherein an aged plating (electroplating) solution is treated. The aged electroplating solution may comprise an accumulated amount of phosphate. In some examples, each of the refreshed plating solution and the original plating solution may comprise cobalt, phosphorous acid, and abrasive particles (e.g., boron carbide)

After the refreshment process, in step 404, a dummy cathode may be electroplated with the refreshed plating solution. A dummy cathode may be subjected to electroplating conditions with the refreshed plating solution for various periods of time to ensure that equilibrium has been reached in the refreshed plating solution. Step 404 may be performed as many times as necessary.

In step 406, the properties of a coating produced by electroplating the dummy cathode in step 404 may be compared with the properties of a coating produced with the original plating solution.

It should be appreciated that in the above description of exemplary embodiments, various features are sometimes grouped together in a single embodiment, figure, or description thereof for the purpose of streamlining the disclosure and aiding in the understanding of one or more of the various aspects. This method of disclosure, however, is not to be interpreted as reflecting an intention that the claimed embodiment requires more features than are expressly recited in each claim. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

### EXAMPLES

The following examples are intended to illustrate the present disclosure without, however, being limiting in nature. It is understood that the present disclosure encompasses additional aspects and embodiments consistent with the foregoing description and following examples.

### Example 1—Removal of Phosphate and Sulfate

0.4 mol/L of iron (III) sulfate (Fe₂(SO₄)₃) was added to a 1.5 liter bath of a plating solution characterized by an accumulation in phosphate anions (PO₄³⁻). Prior to the addition of the Fe₂(SO₄)₃, the pH of the plating solution was determined to be a pH of 1.9. An initial precipitation of the phosphate and phosphite anions was carried out in the plating solution under agitation and heating to a temperature of 80° C. After the Fe₂(SO₄)₃ was completely dissolved in the plating solution, a drop in pH from 1.9 to 0.15 was determined.

1.2 mol/L of barium carbonate (BaCO₃) was slowly added to the plating solution, to precipitate the sulfate anions introduced by the Fe₂(SO₄)₃. The solution was agitated and BaSO₄ precipitation was generated. A rise in pH from 0.15 to 0.58 was determined. After the completion of the BaSO₄ precipitation, the plating solution was filtered using suction filtration.

A clear filtrate solution was retained and cobalt carbonate (CoCO₃) was added to the filtrate. The CoCO₃ was added under agitation to raise the pH of the solution to a pH of 2.2. Upon the addition of the CoCO₃, precipitation reappeared in the solution and iron (III) phosphate and iron (III) phosphite precipitates formed. Agitation was maintained until the precipitation was complete.

After the completion of the precipitation reaction, the solution was filtered using suction filtration to separate the phosphate and phosphite precipitates from the plating solution. Boric acid, phosphorous acid, and boron carbide particles were added to the filtrate to produce a regenerated (refreshed) plating solution having a pH of 1.8.

### Example 2—Plating with Refreshed Plating Solution

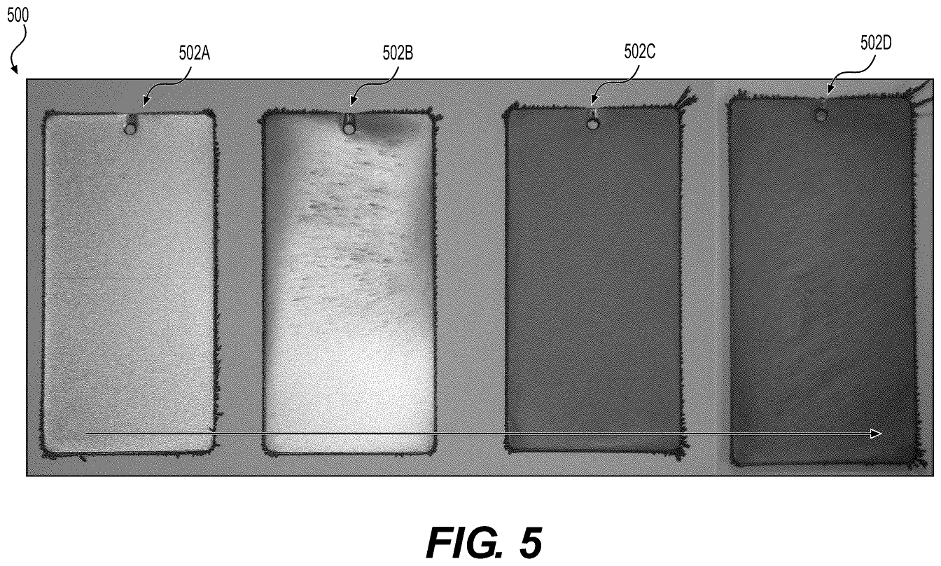

FIG. 5 shows images 500 from assessing a refreshed plating solution, according to Example 1. A dummy cathode was electroplated with the refreshed plating solution from Example 1 at a current density of 50 amps per foot squared (ASF) for four rounds. The electroplated dummy cathode after each round of electroplating with the refreshed plating solution is represented by 502A, 502B, 502C, and 502D. After each round, the coating was observed to return to an appearance comparable to a coating achieved by the original electroplating bath. For example, a change in appearance of the coating of 502A versus the coating of 502D due to the loading of boron carbide (B₄C) particles from the plating solution was observed. After each consecutive round, the coating color changed from a bright color having a shiny appearance as depicted in 502A and 502B to a darker gray color having a dull appearance as depicted in 502D. The change in coating appearance observed after each round to achieve the coating of 502D demonstrates that the boron carbide particles added to the refreshed plating solution produced in Example 1 were co-deposited in the coating shown in 502D. The coating of 502D was considered to have an appearance that is consistent with the appearance of a coating generated with the original electroplating solution.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A method of refreshing a plating solution, the method comprising:
adding a metal sulfate to the plating solution;
precipitating out phosphate anions present in the plating solution with metal ions from the metal sulfate;
adding barium carbonate to the plating solution;
precipitating sulfate introduced from the metal sulfate added to the plating solution with barium from the barium carbonate;
separating insoluble components from the plating solution; and
replenishing the plating solution with components originally present in the plating solution.

2. The method of claim 1, wherein the metal sulfate is selected from aluminum sulfate, iron (II) sulfate, and iron (III) sulfate.

3. The method of claim 2, wherein the metal sulfate is iron (III) sulfate.

4. The method of claim 1, wherein components originally present in the plating solution include a source of cobalt or nickel, phosphorous acid, and additives.

5. The method of claim 1, wherein replenishing the plating solution with components originally present in the plating solution comprises:
adding cobalt (II) carbonate to the plating solution to raise a pH of the plating solution;
generating a precipitate;
separating the precipitate from the plating solution; and
adding phosphorous acid to the plating solution, wherein adding phosphorous acid adjusts the pH of the plating solution.

6. The method of claim 5, wherein at least one of boric acid, boron carbide, silicon carbide, and aluminum oxide is added to the plating solution after the plating solution is separated from the precipitate.

7. The method of claim 1, wherein replenishing the plating solution with components originally present in the plating solution restores a pH of the plating solution.

8. The method of claim 7, wherein the pH of the plating solution ranges from about 1.8 to about 2.

9. The method of claim 1, wherein phosphite anions present in the plating solution are precipitated with metal ions from the metal sulfate.

10. The method of claim 1, wherein the metal sulfate is added to the plating solution after an accumulation of phosphate has been detected.

11. The method of claim 1, wherein the plating solution is an electroplating bath.

12. The method of claim 1, wherein the plating solution is an electroless plating bath.

13. A refreshed plating solution prepared according to the method of claim 1.

14. A method of assessing a refreshed plating solution, the method comprising:
(a) generating a refreshed plating solution from a plating solution after the plating solution has been aged from an original plating solution;
(b) electroplating a dummy cathode with the refreshed plating solution; and
(c) comparing properties of a coating produced in step b. with properties of a coating produced by electroplating with the original plating solution.

15. The method of claim 14, wherein step a. comprises:
adding a metal sulfate to the plating solution;
precipitating out phosphite anions and phosphate anions present in the plating solution with metal ions from the metal sulfate;
adding barium carbonate to the plating solution;
precipitating sulfate introduced from the metal sulfate added to the plating solution with barium from the barium carbonate;
separating insoluble components from the plating solution; and
replenishing the plating solution with components present in the original plating solution.

16. The method of claim 14, wherein at least step b. is repeated one or more times.

17. The method of claim 14, wherein each of the refreshed plating solution and the original plating solution comprises cobalt, phosphorous acid, and abrasive particles.

18. The method of claim 17, wherein the abrasive particles include boron carbide, boron nitride, silicon carbide, aluminum oxide, or a combination thereof.

19. A method of refreshing a plating solution containing a plating metal, the method comprising:
determining a total amount of phosphite anions and phosphate anions in the plating solution;
determining an amount of a metal sulfate compound required to precipitate the total amount of phosphite anions and phosphate anions;
adding the determined amount of the metal sulfate compound to the plating solution;
maintaining the metal sulfate compound in the plating solution for a period of time sufficient to achieve precipitation of the total amount of phosphite anions and phosphate anions;
determining an amount of barium carbonate needed to precipitate the amount of sulfate introduced from the metal sulfate compound added to the plating solution;
adding the determined amount of barium carbonate to the plating solution;
maintaining the barium carbonate in the plating solution to achieve precipitation of the sulfate;
separating the precipitates from the plating solution;
adjusting a pH of the plating solution to cause precipitation; and
adding components back to the plating solution to produce a refreshed plating solution.

20. The method of claim 19, wherein the plating metal includes cobalt, nickel, or a combination thereof.
